(19) United States
(12) Patent Application Publication
(10) Pub. No.: US 2003/0097289 A1
(43) Pub. Date: May 22, 2003

(54) Business management system, method, and program

(76) Inventors: Masao Koide, Yokohama-shi (JP); Toyoji Ikezawa, Yokohama-shi (JP)

Correspondence Address: Alex Chartove, Morrison & Foerster LLP, Suite 300, 1650 Tysons Blvd., McLean, VA, 22102, US

(21) Appl. No.: 10/286,965

(22) Filed: Nov. 4, 2002

(30) Foreign Application Priority Data
Nov. 2, 2001 (JP) 2001-338385

(51) Int. Cl. G06F 17/60

(52) U.S. Cl. 705/8

(57) ABSTRACT

For efficiently forming a sales team, a SFA server reads prescribed customer data of a prescribed case from various customer data previously stored in a customer DB. The SFA server determines if the prescribed case needs sales team formation in a business meeting in accordance with the content of the customer data. If it is determined that the business meeting of the prescribed case needs sales team formation, the SFA server designates a sales person who forms a sales team, and generates request information requesting sales team formation. The SFA server transmits the requesting information to the terminal of the designated sales person.

### CROSS-REFERENCE TO RELATED APPLICATIONS

This application claims priority under 35 USC §119 to Japanese Patent Application No. 2001-338385 filed on Nov. 2, 2001, the entire contents of which are herein incorporated by reference.

### BACKGROUND OF THE INVENTION

1. Field of the Invention

The present invention relates to a business management system, method, and program, and in particular, to a business management system, method, and program for forming a sales team in a business meeting held on a prescribed item with a customer using a network.

2. Discussion of the Background Art

Conventionally, when forming a sales team, a sales person who is in charge of a business meeting with a customer on a prescribed item may need help from other sales persons. Those other sales persons (hereinafter referred to as a specialized sales persons) may be from the same company or from different companies (that work on a consignment basis, for example) and who are skilled of a specified product. Such a jointly formed sales team is typically formed by means of either electronic mail or telephone.

As a result, unproductive labor and time are necessitated by such communications before forming the sales team.

In view of the above described problem, the present invention attempts to provide a business management system or the like capable of efficiently forming a sales team and performing operational activities. The present invention also attempts to provide a business management system or the like capable of reducing or eliminating the labor and time which are generally needed when a sales team is formed.

### SUMMARY OF THE INVENTION

Accordingly, an object of the present invention is to address and resolve the above-noted and other problems and provide a new business management system, method, and program. The above and other objects are achieved according to the present invention by providing a novel business management system, method, and program, which requests a prescribed sales person for forming a sales team in a prescribed case of a business meeting. The business management system includes a business meeting data memory stored with business meeting data representing details of a business meeting held with a customer, a business meeting data reading device configured to read prescribed business meeting data of a prescribed case from the business meeting data memory, a determining device configured to determine if the prescribed case requires sales team formation in a business meeting in accordance with the business meeting data of the prescribed case, and a sales person designating device configured to designate a sales person who forms a sales team, if the business meeting of the prescribed case needs the sales team formation. A request information generating device is included so as to generate request information requesting sales team formation. A request information transmitting device is also included so as to transmit the request information to a terminal of the designated sales person.

In another embodiment, the business management system can further include a priority memory stored with priority data to be used for designating a sales person, who forms a sales team, in accordance with a prescribed business level indicated by the business meeting data, a sales person priority memory stored with sales person forming a sales team and priority data assigned thereto, and a priority designating device configured to designate a appropriate priority in accordance with the business meeting data of the case. The sales person designating device can designate a sales person having the priority by referring to the priority data stored in the sales person priority memory.

In yet another embodiment, the prescribed level can be any one of an expected investment amount and a fact of approach of a rival company to a customer.

In yet another embodiment, the business management system can include a schedule data memory stored with schedule data representing schedule of sales persons In addition, the sales person specifying device can refer to the schedule data and specifies an available sales person having the designated priority as a sales person who forms a sales team.

In yet another embodiment, the business management system can include a going information obtaining device configured to obtain going information representing going of a case from business meeting data stored in the business meeting data memory. In addition, the going information obtaining device can generate request information by including the going information.

In yet another embodiment, the business management system can includes an inputting device configured to allow input of business meeting data, a case identifying data generating device configured to generate case identifying data from one or more prescribed items included in the business meeting data; a case identifying data memory stored with the case identifying data, and a case identifying data writing device configured to write case identifying data in the case designation memory.

In yet another embodiment, one or more prescribed items can include at least any one of an occurrence date of a business meeting in a case, a name of a sales company, whom a business meeting is cooperatively held, a name of a sales person who has held a business meeting with a customer, and a name of a product on which a business meeting was held.

In yet another embodiment, the business management system can includes a case type determining device configured to determine a case type in accordance with characteristics of a case indicated by the business meeting data; an operation information generating device configured to generate operation information representing details to be operated by a sales person forming a sales team in the case of the case type; and an operation information transmitting device configured to transmit the operation information to a terminal of the designated sales person forming the sales team.

In yet another embodiment, a computer readable program executes the following procedure when read by a computer. The procedure includes the steps of: reading business meeting data of a prescribed case from the business meeting data memory; determining if the prescribed case requires sales team formation in a business meeting in accordance with the business meeting data of the prescribed case; designating a sales person who forms a sales team, when the business meeting of the case needs sales team formation; generating request information requesting sales team formation; and transmitting the request information to a terminal of the designated sales person.

Thus, a sales person can be efficiently determined, and accordingly, labor and time required therefor can be reduced.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block chart illustrating an example of a business management system as one embodiment according to the present invention;

FIG. 2 is a chart illustrating an example of a SFA server included in FIG. 1;

FIG. 3 is a chart illustrating an example of a memory included in FIG. 2;

FIG. 4 is a chart illustrating an example of a case number file included in FIG. 3;

FIG. 5 is a chart illustrating an example of a case type list included in FIG. 3;

FIG. 6 is a chart illustrating an example of an operation item list included in FIG. 3;

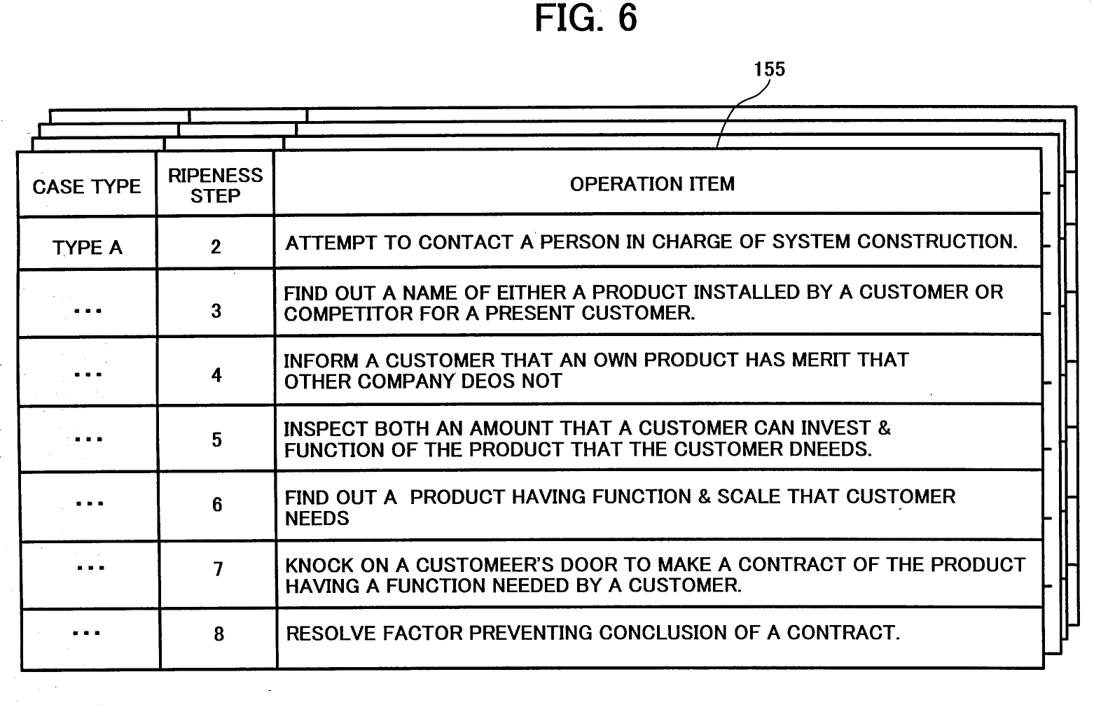

FIG. 7 is a chart illustrating an example of a specialized person determination list included in FIG. 3;

FIG. 8 is a chart illustrating an example of a rival company's approach priority list included in FIG. 3;

FIG. 9 is a chart illustrating an example of an expected investment amount priority list included in FIG. 3;

FIG. 10 is a chart illustrating an example of a schedule file included in FIG. 3;

FIG. 11 is a flowchart illustrating an example of an operation of determining a case number assigned to customer data of a new case;

FIG. 12 is a flowchart illustrating an example of a process of asking a sales person to form a sales team and notification of going of a business meeting;

FIG. 13 is a chart illustrating an example of a request information display screen or the like;

FIG. 14 is a chart illustrating an example of the other request information display screen or the like;

FIG. 15 is a flowchart illustrating an example of a process of notifying details of operation activities when a sales team is formed and operation activities are to be performed; and

FIG. 16 is a chart illustrating an example of an operation item display screen.

### PREFERRED EMBODIMENT

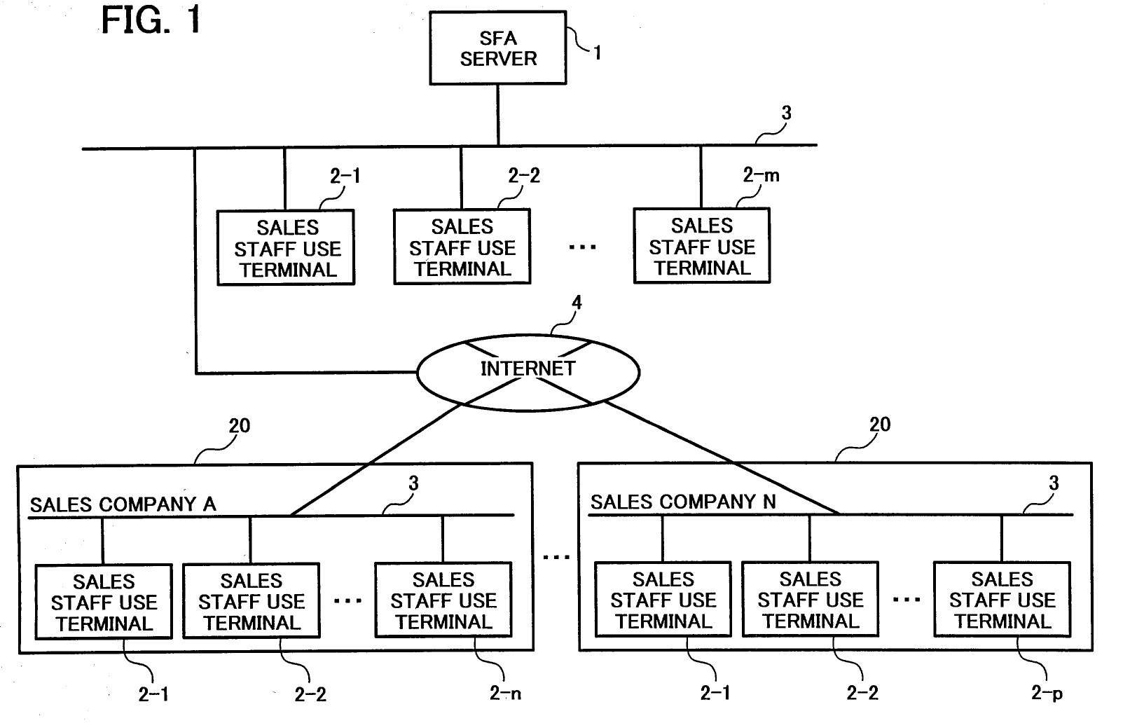

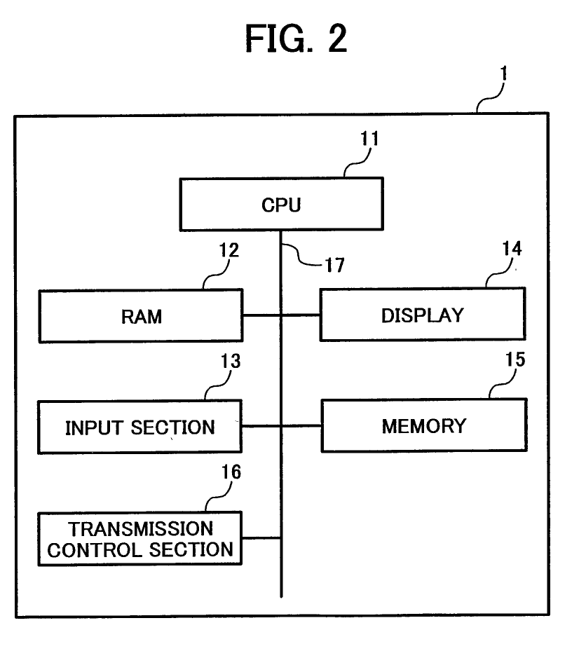

Referring now to the drawings, wherein like reference numerals designate identical or corresponding parts throughout the several views, in particular, in FIG. 1, an example of a business management system is illustrated as one embodiment according to the present invention. The business management system of this embodiment includes an SFA (Sales Force Automation) server 1, a plurality of sales staff use terminals 2 (2-1 . . . 2-m, wherein “m” represents the total number of sales staff use terminals 2 installed in their own companies), and other sales staff use terminals 2 (2-1 . . . 2-n, and 2-1 . . . 2-p, wherein “n” and “p” represent the total numbers of sales staff use terminals 2 installed in the respective sales companies A to N). The respective SFA server 1 and sales staff use terminals 2 of their own companies are connected to a LAN (Local Area Network) 3. Each of the sales staff use terminals 2 in the sales companies A to N is connected to a LAN 3 provided in each of the sales companies. The SFA server 1 is a server for managing operation activities of a product. The SFA server 1 includes a CPU (Central Processing Unit) 11, a RAM (Random Access Memory) 12, an inputting section 13, a display section 14, a memory 15, and a transmission control section 16 as illustrated in FIG. 2. The respective sections are connected to a bus 17.

The CPU 11 stores a control program such as system program (i.e., OS) stored in a memory 15 and various application programs, executed by the system program or the like, in the RAM 12, and executes a later described processing in accordance with the control program.

The RAM 12 is stored with the above-described control program, input designation contents and data, and processed resultant.

An input section 13 includes a keyboard equipped with, for example, a cursor, a numeric input, and various function keys. The input section 13 outputs a signal to the CPU 11 upon key depression on the keyboard. The display section 14 is configured from a liquid crystal display panel or the like, and displays information representing the running condition of the SFA server 1, for example.

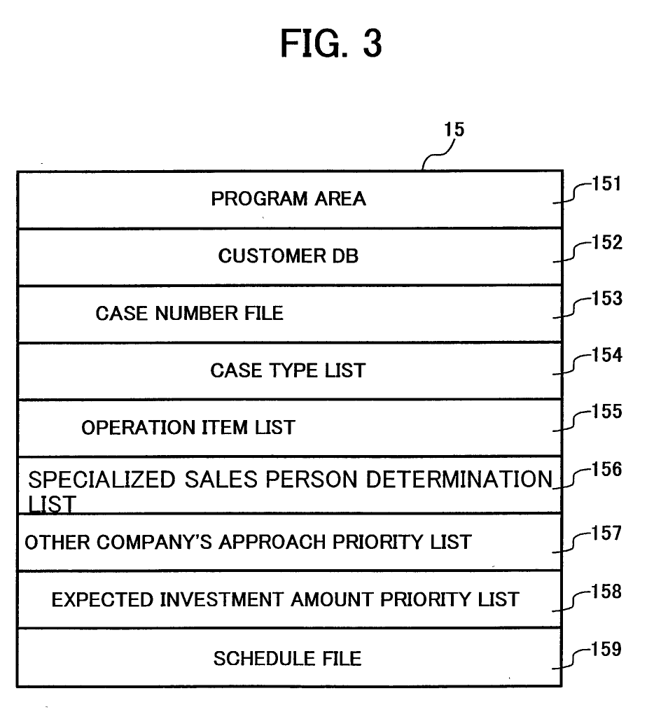

The memory 15 is configured from a hard disc or the like, and includes a program area 151 for storing the control program as illustrated in FIG. 3. The memory 15 stores a customer DB (Database) 152, a case number file 153, a case type list 154, an operation item list 155, a specialized person determination list, a rival company's approach priority list 157, an expected investment amount priority list 158, and a schedule file 159.

The customer DB 152 is stored with customer data constructed from customer information and business meeting information. The business meeting information indicates the details of a business meeting held with a customer. The customer DB 152 is also stored with the following information when a customer is a party. Specifically stored are: the name of the party (company), an address (seat), the name and age of a representative; the capital fund and business category of the customer, a sales amount, a bottom line, and the gain of the last fiscal year, a score (maximum 100) evaluated and given to the customer by a credit research company, and the name of a unit included in the party. Also, the name of a person in charge and belonging to the unit, telephone and facsimile numbers, a mail address, and the job title of the person are stored in parallel to the above-described information.

The customer DB 152 is also stored with information regarding planning and practical accomplishment of operation activities while parallelizing each of those to a customer and a case in progress. For example, the customer DB 152 is stored with information, such as the product code assigned to a product to be sold to the customer, a product group code assigned to a product group that the product belongs to, a transaction case identification identifying a case of transaction with a customer, for example by parallelizing it to the above-described unit. The customer DB 152 is also stored with information representing the difference between the planning and the practical accomplishment (hereinafter referred to as “plan ripeness”) executed in the case while parallelizing it to the transaction case identifying information.

The above-described plan ripeness may be classified into the following nine steps (1) to (9) (hereinafter referred to as “ripeness steps”) in accordance with midterm targets (hereinafter referred to as a “ripeness level”) that should be achieved for completing a transaction. First is the step of attempting a contact, such as a first call to a new customer. Second is the step of establishing an association with a customer by attempting to have a nodding acquaintance with staff of a main unit and business job site of the customer. Third is the step of performing close investigation by researching facts, such as equipment in possession of a customer, a competitor, etc., expected to have an effect on the feasibility and conditions of a contract. Fourth is the step of arousing interest on the part of the customer. Fifth is the step of grasping an amount of investigation, and the product or the like sought by the customer. Sixth is the step of sounding and extracting a problem to be resolved in order to furnish a product sought by the customer. Seventh is the step of proposing in earnest a contract to furnish the product. Eighth is the step of removing a contributing factor that is discouraging conclusion of the contract. Ninth is the step of concluding the contract. These ripeness steps are getting higher (i.e., close to completion of the transaction) as the step advances from one to nine.

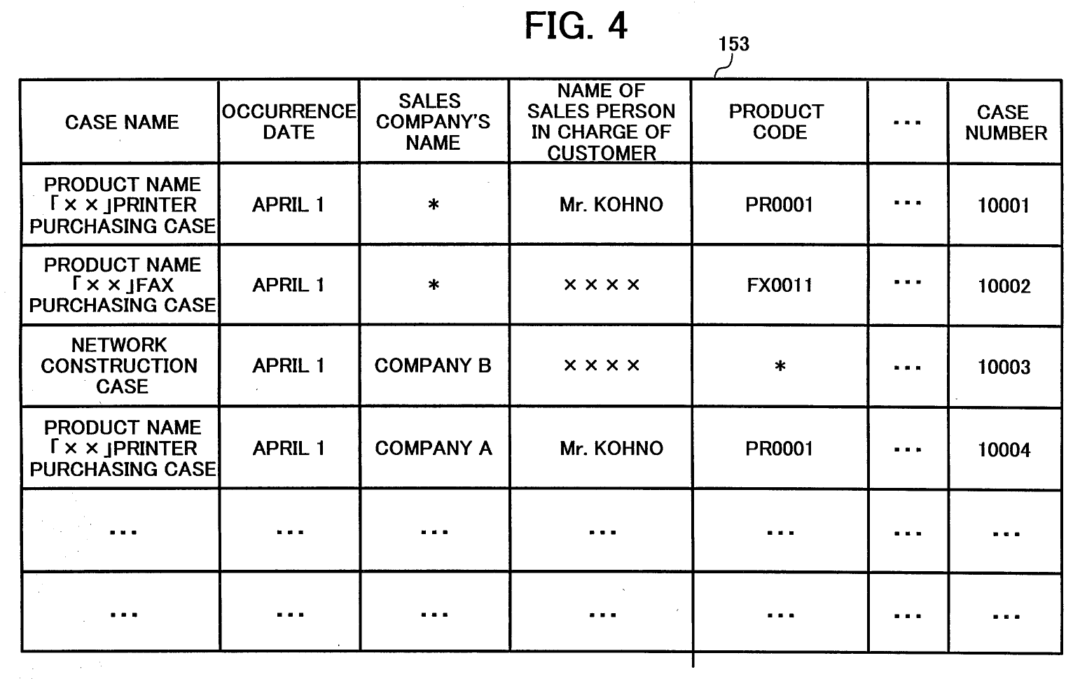

The case number file 153 is stored with case number related data that specifies the case of a business meeting held with the customer. As illustrated in FIG. 4, the case number data includes various data items, such as the name of the case, the name of the sales company (if operation activities performed in a case are cooperatively performed therewith), a sales person in charge of the case, a code of a product that is an objective of the case, and a case number assigned to the case name. The reason why a case number file 153 is employed is that if a case name indicates “a printer purchasing case,” for example, then several customer data having the same case name is probably stored in the customer DB 152, and the desired customer data cannot be specified using the case name alone.

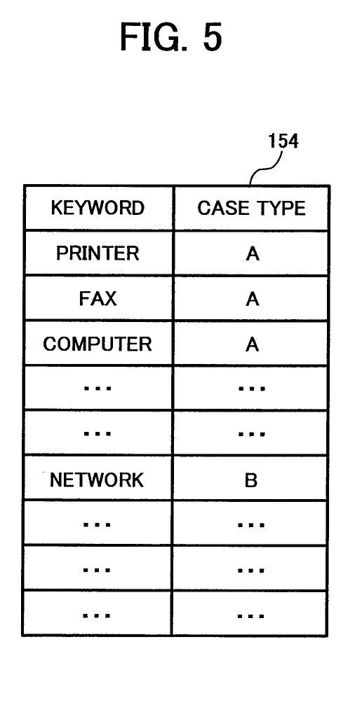

The case type list 154 determines the type of a case in accordance with a case name specified by the case number of the customer data. As illustrated in FIG. 5, the case type list 154 includes the name of the case type and a keyword for specifying the case type. Specifically, there exist types “A” and “B”. The type A case may represent a business meeting on selling a stand-alone type product, such as a printer, a facsimile, etc. In contrast, the type B case may represent a business meeting on a network construction, for example.

The operation item list 155 includes information representing details of operation activities to be operated by a sales person for a customer in respective ripeness steps per a case type.

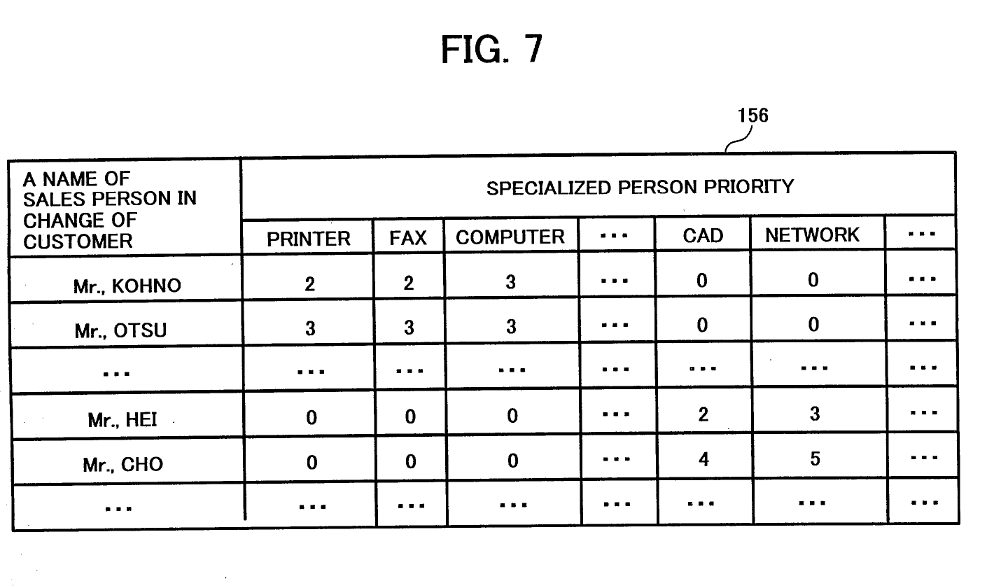

The specialized sales person determination list 156 is used when a specialized sales person forming a sales team is determined. The list 156 includes the names of specialized sales persons and their priorities per a product or network construction business, as illustrated in FIG. 7. The specialized sales person priority is lowest when it is a “1” and highest when it is a “5.” Priority is given in accordance with a prescribed skill, for example.

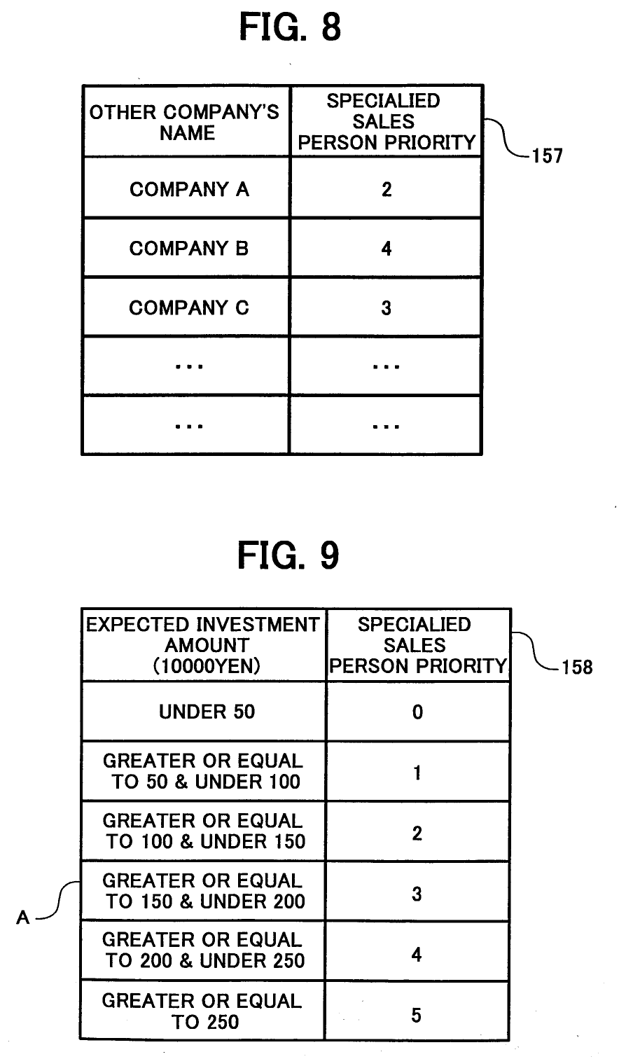

A rival company's approach priority list 157 is used in order to change a specialized sales person upon needs so as to compete with a rival company, when a rival company has contacted the customer, and accordingly, a business meeting is to be promoted in a prescribed case. As illustrated in FIG. 8, the rival company's approach priority list 157 may include names of competitive companies, and priorities of specialized sales persons (for determining a prescribed one or more specialized sales persons) dispatched in order to compete with the competitive company.

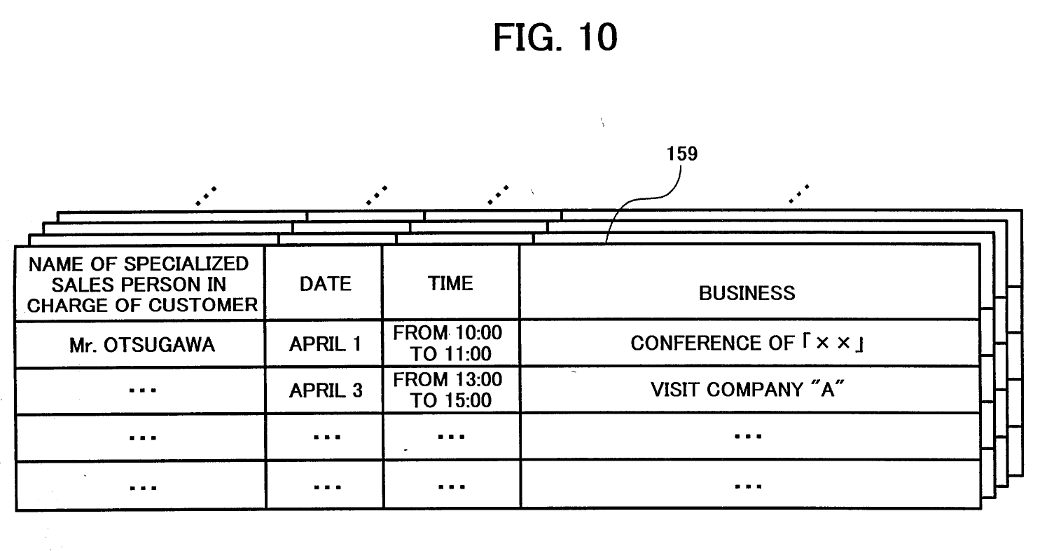

The expected investment amount priority list 158 is used to select a prescribed specialized sales person who will form a sales team in accordance with an expected amount of investment of a customer. As illustrated in FIG. 9, the expected investment amount priority list 158 may include items such as an expected investment amount, a specialized sales person priorities given in accordance with the expected investment amount, etc. The specialized sales person priorities may range from “0” to “5,” where “0” indicates that no specialized sales person is required for the sales team, and “5” indicates that the most specialized sales person is required to join the sales team.

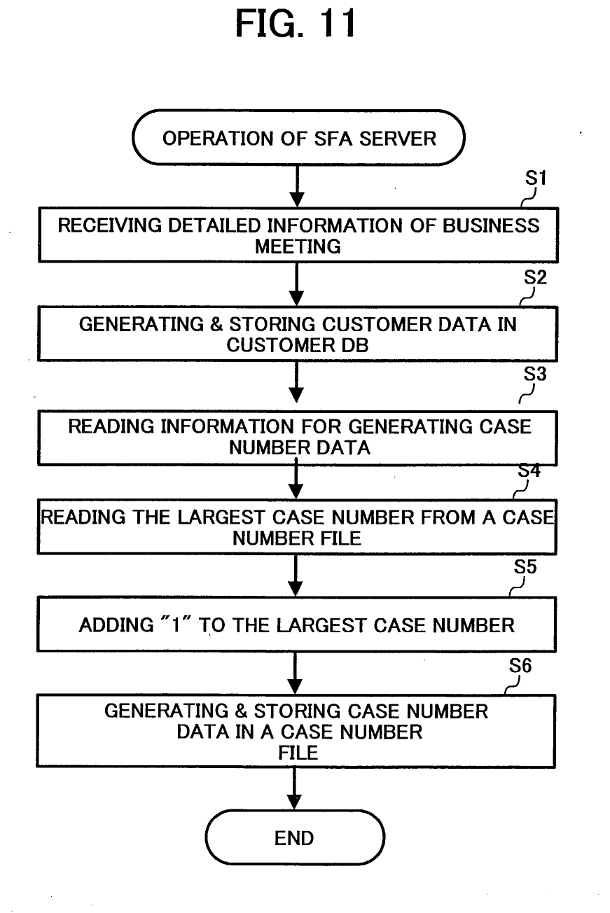

The schedule file 159 is stored with schedule data representing the schedules of specialized and normal sales persons during a prescribed term. As illustrated in FIG. 10, the schedule data may include various data items such as the names of sales persons, dates and times, details of activities to be performed during the dates and times, etc. The transmission control section 16 controls data communication with the sales staff using terminal 2.

Each of sales staff use terminals 2 and 3 of their own and the sales companies A to N illustrated in FIG. 1 includes a CPU, a RAM, an inputting section, a display, a memory, and a transmission control section (not shown), each connected to the bus. The CPU executes processing in accordance with a control program stored in the RAM.

The RAM is stored with the control program, input designation contents, input data, and processed resultant. The inputting section includes a keyboard equipped with a cursor, numeral inputting, and various function keys, and a mouse serving as a pointing device. A CRT and liquid crystal display panel and so on collectively configure the display section. The memory is configured by a hard disc or the like and is stored with the control program. The transmission control section controls communication of data and similar with the SFA server.

Various operations of the business management system of this embodiment are now described with reference to three types of operations respectively performed when a case occurs and a case number is assigned thereto, when sales team formation request information is notified, and when operation items to be operated by a sales team when business activities are performed.

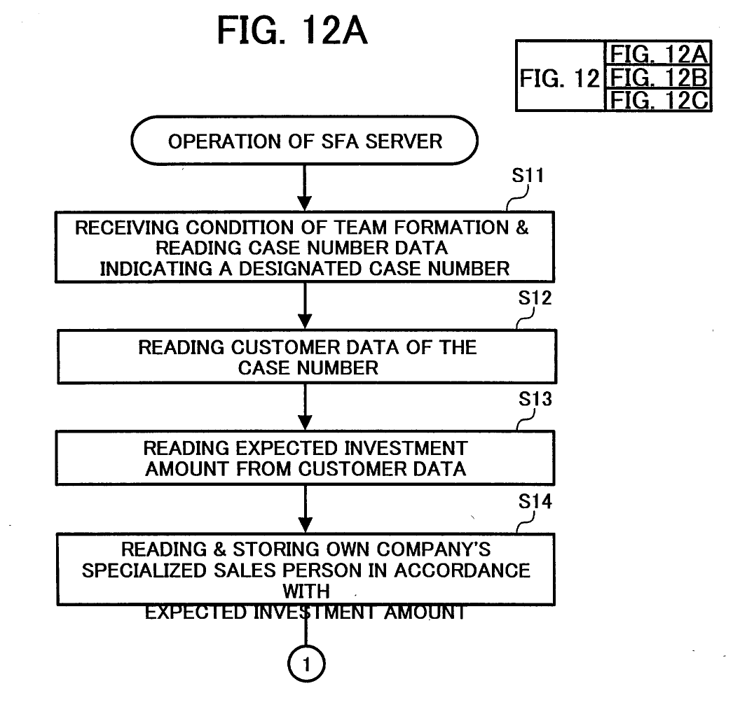

First, the operation of assigning a case number to a new case upon its occurrence is now described with reference to FIG. 11.

Upon receiving information representing details of business meeting held with a customer from a prescribed sales staff use terminal 1 (step S1), the SFA server 1 generates prescribed customer data from the information, and stores it in the customer DB 152 (step S2). The SFA server 1 reads prescribed information from the customer data, such as “product name xxx printer purchasing case” as a case name, “April 1” as an occurrence date, “company A” as a sales company cooperatively performing business activities, “Mr. Kohno” as a name of a sales person in charge, “PR0001” as a product code, etc., to generate and store the case number data in the RAM 12 (step S3). Then, the SFA server 1 retrieves and reads “10003” as the largest case number from the case number file 153 shown in FIG. 4 (step S4), and stores “10004” by incrementing the largest case number by “1” in the RAM 12 (step S5).

Then, the SFA server 1 generates case number related data ¹⁵³, indicating “product name xxx printer purchasing case” as a case name, “April 1” as an occurrence date, “company A” as a sales company that cooperatively performs business activities, “Mr. Kohno” as a name of a sales person, “PR0001” as a product code, etc., for the case number “10004” as shown in FIG. 4. The SFA server 1 then stores the generated case number corresponding data 1531 in the case number file 153 (step S6), and terminates the operation.

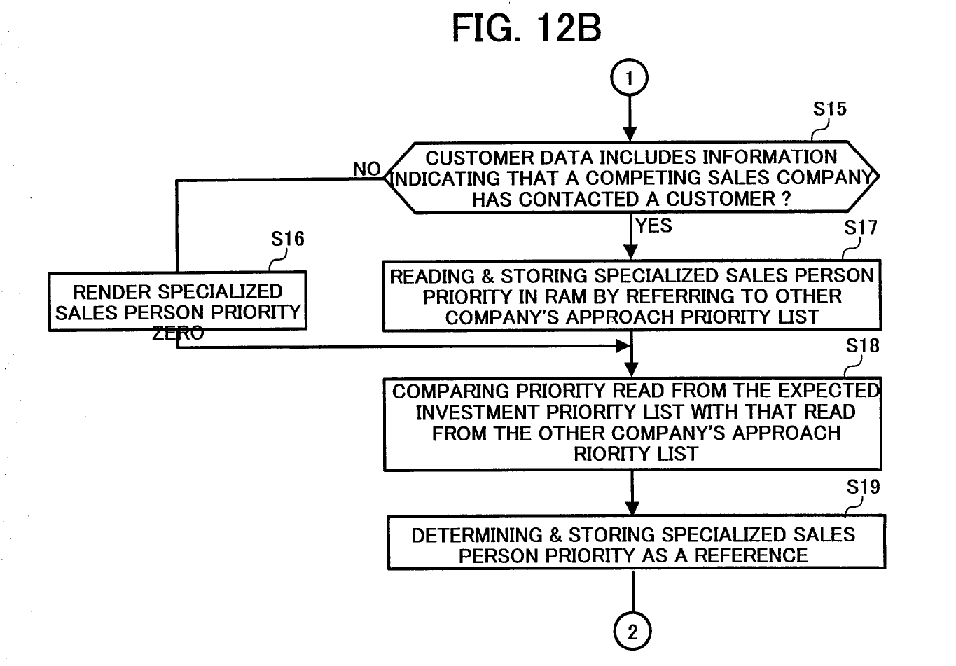

The operation of requesting a sales team for sales team formation is now described with reference to the flowchart shown in FIG. 12.

When the sales staff use terminal 2 of the sales person “Mr. Kohno” for example, designates a specialized salesperson of its own company or sales company (hereinafter simply referred to as a specialized sales person), who will form a sales team from 1:00 PM to 4:00 on May 1 for the case “10004”, and instructs the SFA server 1 to transmit such a sales team formation request to prescribed applicable sales staff use terminals 2, the SFA server 1 reads case number data 153₁ given the case number of “10004” from the case number file 153.

The SFA server 1 then reads customer data including “product name xxx printer purchasing case” as a case name, “April 1” as an occurrence date, “company A” as a sales company, “Mr. Kohno” as a name of a sales person in charge, and “PR0001” is a product code included in the case number correspondence data 153₁ from the customer DB 152 (step S12).

The SFA server 1 then reads an expected investment amount, for example “1.7 million Yen”, of the customer from the customer data (step S13).

After reading the expected investment amount of “1.7 million Yen”, the SFA server 1 refers to the expected investment priority list 158, and reads and stores a specialized sales person priority level “3” serving as a reference for determining a prescribed own company's specialized sales person in charge, who forms a sales team (step S14). In such a situation, if the priority “0” is read as a specialized sales person priority by the SFA server 1, then such a case is regarded as not requiring a specialized sales person on the sales team.

Subsequently, the SFA server 1 determines if the read customer data includes information indicating that a competitive sales company has contacted the customer (step S15).

If a competitive sales company has not yet contacted the customer (i.e., “No” in step S15), then the SFA server 1 determines a prescribed specialized sales person priority, which serves as a reference for determining a specialized sales person who forms the sales team, as “0”. The SFA server 1 then stores the specialized sales person priority “0” in the RAM 12 (step S16) and the process moves to step S18. In contrast, if a sales company A, for example, has contacted the customer (i.e., “Yes” in step S15), then the SFA server 1 refers to a rival company's approach priority list 157, and reads and stores the level “2” as a specialized sales person priority in the RAM 12 (i.e., “Yes” in step S17). Such a priority is given in accordance with a sales step.

After storing the specialized sales person priority “2” in the RAM 12, the SFA server 1 compares the specialized sales person priority “3” with that of the specialized sales person priority “2” (step S18), and determines the specialized sales person priority “3” as a priority for this case (step S19). Then, the SFA server 1 refers to the specialized sales person list 156 shown in FIG. 7, and reads and stores a corresponding specialized sales person “Mr. Otsugawa” having the specialized sales person priority “3” for the business meeting on printer purchasing in the RAM 12 (step S20).

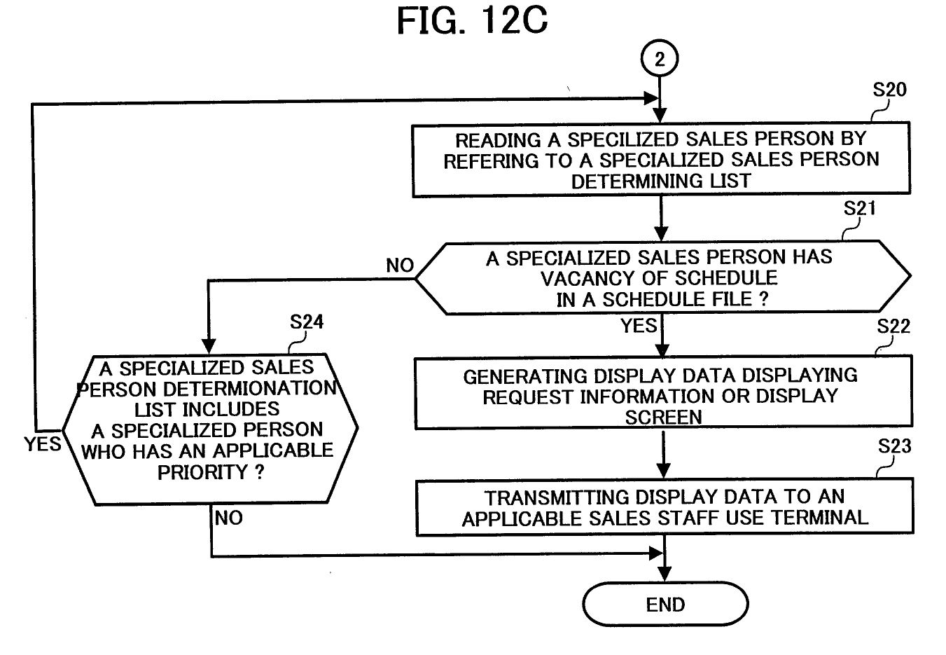

Subsequently, the SFA server 1 refers to the schedule file 159 and determines if the schedule of Mr. Otsugawa is open from 1:00 to 4:00 PM on May 1 (step S21). If the SFA server 1 determines that the schedule of Mr. Otsugawa is open (i.e., “Yes” in step S21), then the SFA server 1 generates display data that displays a display screen 500 indicating request information as shown in FIG. 13 on the sales staff use terminal 2 of Mr. Otsugawa (step S22), and transmits such display data to the sales staff use terminal 2 of Mr. Otsugawa (step S23). Thereby, the process is terminated.

Upon receipt of the display data, the sales staff use terminal 2 of Mr. Otsugawa stores the display data in the memory 25. Upon receipt of an instruction as to displaying of the display data on the display 24 through the operation of Mr. Otsugawa, the sales staff use terminal 2 displays the display data on the display 24.

In contrast, if the SFA server 1 determines that the schedule of Mr. Otsugawa is booked (i.e., “No” in step S21), then the SFA server 1 determines if a specialized sales person who has a specialized sales person priority “3” exists other than Mr. Otsugawa (step S24).

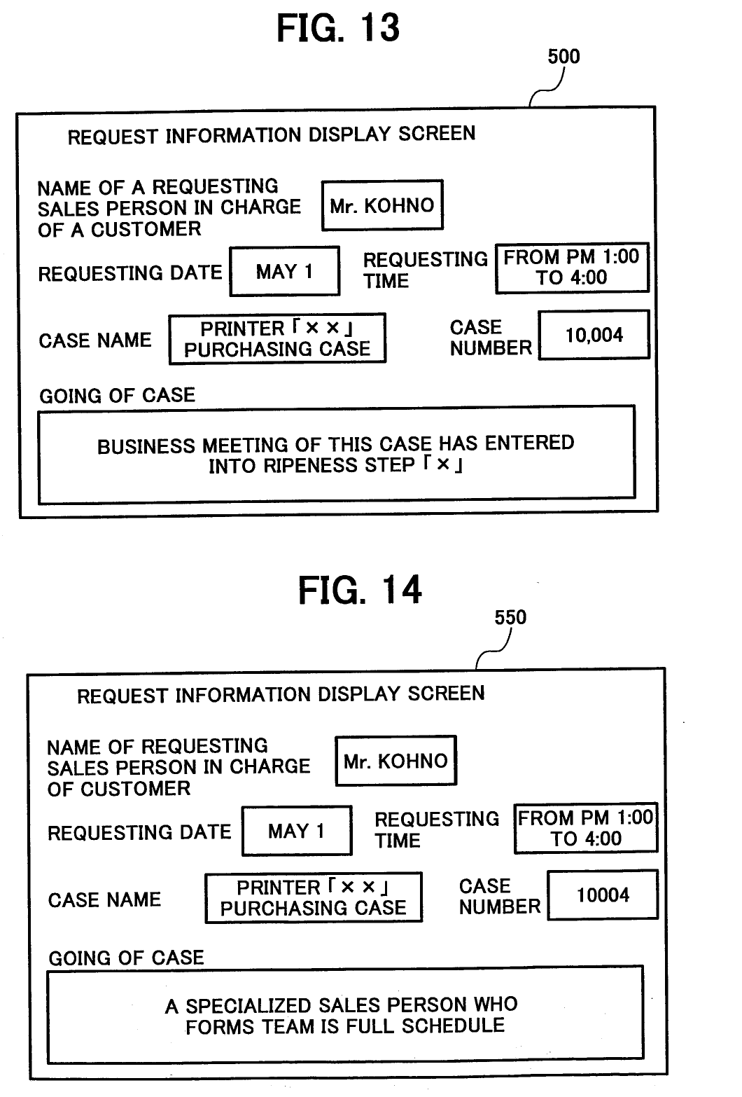

If the SFA server 1 determines that the other specialized sales person exists (i.e., “Yes” in step S24), then the SFA server 1 moves the process to step S20, and performs the same operation as described earlier. In contrast, if the SFA server 1 determines that the other specialized sales person does not exist (i.e., “No” in step S24), then the SFA server 1 transmits display data that displays a display screen 550 representing that the schedule of the sales person who forms a sales team has been already booked as shown in FIG. 14 to the sales staff use terminal 2 of Mr. Kohno.

Upon receipt of the display data, the sales staff use terminal 2 of Mr. Kohno stores and displays the receipt display data when operated.

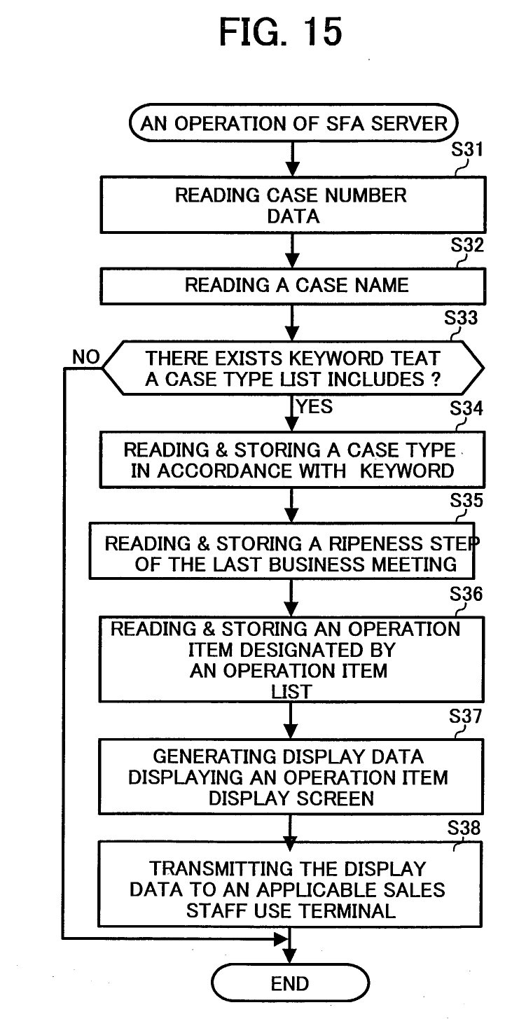

An operation of notifying operation items when a sales team performs business activities is now described with reference to FIG. 15. Upon receiving an instruction from the sales staff use terminal 2 of Mr. Kohno as to notification of operation items, for example, of a case number “10004” to the sales staff use terminals 2 of him and a specialized sales person or a sales person of the sales company so to form a sales team, the SFA server 1 reads case number related data 153₁ indicating the case number “10004” from the case number file 153 of FIG. 4 (step S31). Then, the SFA server 1 reads a case name of “product xxx printer purchasing case” included in the case number related data 153₁ (step S32).

The SFA server 1 subsequently determines if a keyword included in the case type list is included in the case name of “product xxx printer purchasing case” (step S33). If SFA server 1 determines that the keyword is excluded from the case name (i.e., No in step S33), for example, the SFA server 1 terminates the operation. In contrast, if SFA server 1 determines that the keyword is included in the case name due to the fact that, the case type list 154 includes the keyword “a printer” (i.e., Yes in step S33), the SFA server 1 reads and stores the code “A” in the RAM 12 as a case type given to “a printer” (step S34).

After storing the code “A” in the RAM, the SFA server 1 reads a ripeness step, for example “5”, marked in the last business meeting from the customer data (such as a record of visiting) of the sales person “Mr. Kohno” stored in the customer DB 152, and stores it in the RAM 12 (step S35).

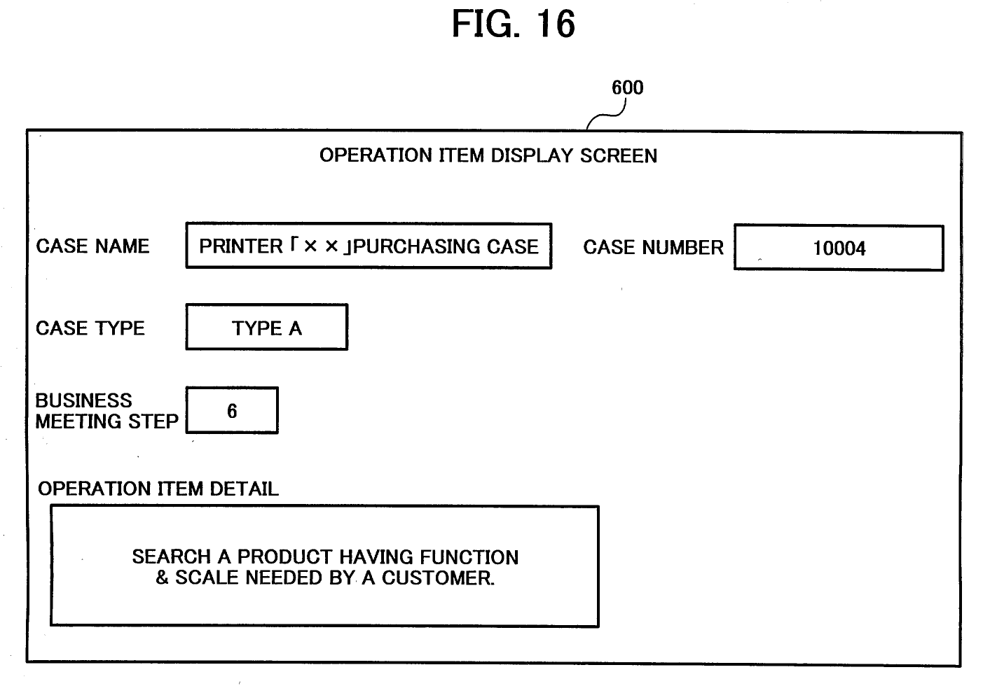

In accordance with the “type A” and ripeness step “5”, the SFA server 1 reads from the operation item list 155 of FIG. 5 and stores in the RAM 12 an operation item indicating “research if a product having a function and scale satisfying customer needs exists” assigned to a situation when the case type is “A” and ripeness step is “5”, (step S36). Then, the SFA server 1 generates display data displaying the operation item display screen 600 as shown in FIG. 16 on the sales staff use terminal 2 while using the above-described operation items stored in the RAM 12 (step S37).

Then, the SFA server 1 transmits the display data to sales staff use terminals 2 of Mr. Kohno as a (progress step confirmation) request source, and a specialized sales person or sales person of a sales company, who will forms a sales team, via a LAN 3 and Internet 4 (step S38) or the like, and terminates the operation.

Upon receipt of the display data from the SFA server 1, the sales staff use terminals 2 of Mr. Kohno and either a specialized sales person or a sales person of a sales company, who will form a sales team, stores the display data in the memory apparatus. Then, these sales staff use terminals 2 and 3 display the operation item display screens including the display data stored in the memory on respective display sections in accordance with an operation of an operator.

Obviously, numerous additional modifications and variations of the present invention are possible in light of the above teachings. It is therefore to be understood that within the scope of the appended claims, the present invention may be practiced otherwise than as specifically described herein.

What is claimed is:

1. A business management system for forming a sales team through a network for a prescribed business meeting, said business management system comprising:
a business meeting data memory stored with business meeting data representing details of a business meeting held with a customer;
a business meeting data reading device configured to read prescribed business meeting data of a prescribed case from the business meeting data memory;
a determining device configured to determine if the prescribed case requires sales team formation for a business meeting in accordance with the business meeting data of the prescribed case;
a sales person specifying device configured to specify a sales person who forms a sales team, if the prescribed case needs sales team formation;
a request information generating device configured to generate request information requesting team formation; and
a request information transmitting device configured to transmit the request information to a terminal of the specified sales person.

2. The business management system, according to claim 1, further comprising:
a priority data memory stored with data of priority given among prescribed business meeting levels included in the business meeting data;
a sales person priority memory stored with data of sales persons and priorities assigned thereto per a business meeting objective in forming a sales team; and
a priority designating device configured to designate prescribed priority stored in the priority data memory in accordance with the contents of the business meeting data of the prescribed case,
wherein said sales person specifying device refers to the designated prescribed priority data and specifies the sales person having the designated prescribed priority.

3. The business management system, according to claim 2, wherein said prescribed business meeting level is one of an expected investment amount and a rival company who has approached a customer.

4. The business management system, according to claim 2, further comprising a schedule data memory stored with schedule data representing schedule of sales persons capable of forming a sales team, wherein said sales person specifying device refers to the schedule data, and specifies an available sales person having the designated prescribed priority as a sales person who forms a sales team.

5. The business management system, according to claim 1, further including a going information obtaining device configured to obtain going information representing going of the case from the business meeting data; wherein said going information is included in the request information.

6. The business management system, according to claim 1, further comprising:
a business meeting data inputting device configured to input business meeting data;
a case identifying data memory stored with case identifying data that identifies a case name included in the business meeting data;
a case identifying data generating device configured to generate case identifying data from one or more prescribed items included in the business meeting data; and
a case identifying data writing device configured to write case identifying data in the case identifying data memory.

7. The business management system, according to claim 6, wherein said one or more prescribed data includes at least any one of an occurrence date of a business meeting, a name of a sales company whom a business meeting has been cooperatively held, a name of a sales person having held a business meeting with a customer, and a name of a product on which a business meeting has been held.

8. The business management system, according to claim 1, further comprising:
a case type determining device configured to determine a case type in accordance with characteristics of the case indicated by the business meeting data;
an activity information generating device configured to generate information of activities to be performed by a sales person forming a sales team in accordance with the case type; and
an activity information transmitting device configured to transmit the activity information to a terminal of the sales person forming the sales team.

9. A method for forming a sales team through a network in a prescribed business meeting, said method comprising the steps of:
storing business meeting data in a business meeting data memory;
reading prescribed business meeting data of a prescribed case from the business meeting data memory;
determining if the prescribed case requires sales team formation in a business meeting from the business meeting data of the prescribed case;
specifying a sales person who forms a sales team, if the business meeting of said case needs sales team formation;
generating request information requesting team formation; and
transmitting the request information to a terminal of the specified sales person.

10. The method according to claim 9, further comprising the steps of:
storing priorities given in accordance with a prescribed business meeting levels indicated by the business meeting data; and
referring to the priorities and designating a prescribed priority and specify a prescribed sales person having the designated priority so as to form the sale team.

11. The method according to claim 10, wherein said prescribed business meeting level is one of an expected investment amount of a customer and a rival company who has approached the customer.

12. The method according to claim 10, further comprising the steps of:
referring to previously stored schedule data representing schedule of sales persons capable of forming a sales team; and
designating an available sales person having designated priority as a sales person forming the sales team.

13. The method according to claim 9, further comprising the steps of:
obtaining going information representing going of the case from the business meeting data; and
including the going information in the request information.

14. The method according to claim 9, further comprising the steps of:
inputting business meeting data;
generating case identifying data for identifying a case name included in the business meeting data from one or more prescribed items included in the business meeting data; and
storing case identifying data in the memory apparatus.

15. The method according to claim 14, wherein said prescribed item includes at least any one of an occurrence date of a business meeting, a name of a sales company whom a business meeting has been cooperatively held, a name of a sales person who has held a business meeting with a customer, and a name of a product on which a business meeting has been held.

16. The method according to claim 9, further comprising the steps of:
designating a case type representing characteristics of a case in accordance with the business meeting data;
generating activity information representing activities to be performed by a sales person forming a sales team in the prescribed case; and
transmitting the activity information to a terminal of the sales person forming the sales team.

17. A computer readable program executing the following steps of procedure when read in the computer, said steps of procedure comprising:
reading prescribed business meeting data of a prescribed case from a business meeting data memory;
determining if the prescribed case needs sales team formation in a business meeting from the business meeting data of the prescribed case;
specifying a sales person who forms a sales team, if the business meeting of said prescribed case needs the sales team formation;
generating request information requesting team formation; and
transmitting the request information to a terminal of the specified sales person.

18. A system for forming, via a network, a sales team, the system comprising:
a meeting data memory configured to store meeting data representing details associated with a meeting with a customer,
a meeting data reading device configured to read from the meeting data memory meeting data associated with a case,
a determining device configured to determine whether, in accordance with the meeting data associated with the case, the case requires sales team formation,
a sales person specifying device configured to specify a sales person for the sales team when the case requires sales team formation,
a request information generating device configured to generate request-information requesting sales team formation, and
a request information transmitting device configured to transmit the request information to a terminal associated with the specified sales person.

19. The system of claim 18, wherein the meeting data includes priority data, comprising:
a priority data memory configured to store the priority data,
a sales person priority memory configured to store priority data associated with a sales person, and
a priority designating device configured to designate a priority stored in the priority data memory in accordance with the meeting data,
wherein the sales person specifying device refers to the priority data and specifies a sales person for the sales team in accordance with the designated priority.

20. The system of claim 19, comprising:
a schedule data memory configured to store schedule data associated with a schedule of a potential sales person for the sales team,
wherein the sales person specifying device refers to the schedule data and specifies a sales person for the sales team in accordance with the schedule data.

21. The system of claim 18, comprising:
a meeting data inputting device configured to input meeting data, the meeting data comprising a plurality of items,
a case identifying data memory configured to store case identifying data,
a case identifying data generating device configured to generate case identifying data from at least one item included in the meeting data, and
a case identifying data writing device configured to write case identifying data in the case identifying data memory.

22. The system of claim 21, wherein the at least one item included in the meeting data includes at least one of a date of a meeting, a name of a sales company with whom a meeting has been held, a name of a sales person with whom a customer has met, and a name of a product that has been a subject of a meeting.

23. The system of claim 18, comprising:
a case type determining device configured to determine a case type in accordance with characteristics of a case indicated by the meeting data,
an activity information generating device configured to generate information of activities to be performed by a sales person forming a sales team in accordance with the case type, and
an activity information transmitting device configured to transmit the activity information to a terminal of the sales person forming the sales team.

24. A method for forming, via a network, a sales team, the method comprising:
storing in a meeting data memory meeting data representing details associated with a meeting with a customer,
reading from the meeting data memory meeting data associated with a case,
determining whether, in accordance with the meeting data associated with the case, the case requires sales team formation,
specifying a sales person for the sales team when the case requires sales team formation,
generating request information requesting sales team formation, and
transmitting the request information to a terminal associated with the specified sales person.

25. The method of claim 24, wherein the meeting data includes priority data, comprising:
storing the priority data in a priority data memory,
storing priority data associated with a sales person,
designating a priority stored in the priority data memory in accordance with the meeting data, and
specifying a sales person for the sales team in accordance with the designated priority.

26. The method of claim 25, comprising:
storing schedule data associated with a schedule of a potential sales person for the sales team,
specifying a sales person for the sales team in accordance with the stored schedule data.

27. The method of claim 24, comprising:
inputting meeting data comprising a plurality of items,
storing case identifying data,
generating case identifying data from at least one item included in the meeting data, and
storing case identifying data in a memory.

28. The method of claim 27, wherein the at least one item included in the meeting data includes at least one of a date of a meeting, a name of a sales company with whom a meeting has been held, a name of a sales person with whom a customer has met, and a name of a product that has been a subject of a meeting.

29. The method of claim 24, comprising:
determining a case type in accordance with characteristics of a case indicated by the meeting data,
generating information of activities to be performed by a sales person forming a sales team in accordance with the case type, and
transmitting the activity information to a terminal of the sales person forming the sales team.

30. A computer readable program for executing, when read in a computer, the following steps:
reading meeting data associated with a case, the meeting data representing details associated with a meeting with a customer,
determining whether, in accordance with the meeting data associated with the case, the case requires sales team formation,
specifying a sales person for the sales team when the case requires sales team formation,
generating request information requesting sales team formation, and
transmitting the request information to a terminal associated with the specified sales person.
